(19) United States
(12) Patent Application Publication
(10) Pub. No.: US 2019/0364053 A1
(43) Pub. Date: Nov. 28, 2019

(54) Intelligent Controlled-Environment Facility Resident Communication and Media Device Interfaces with Application Program Use Countdowns

(71) Applicant: Securus Technologies, Inc., Dallas, TX (US)

(72) Inventors: Alice J. Clements, Coppell, TX (US); Luke Keiser, Frisco, TX (US)

(73) Assignee: SECURUS TECHNOLOGIES, INC., Dallas, TX (US)

(21) Appl. No.: 14/788,117

(22) Filed: Jun. 30, 2015

(51) Int. Cl. H04L 29/06; G06F 3/0484

(52) U.S. Cl. CPC H04L 63/108; G06F 3/0484

(57) ABSTRACT

A controlled-environment facility resident interface runs on top of, or as a part of, an operating system of a controlled-environment facility resident communication and/or media device. The interface may request, accept and verify identification information from a resident of the controlled-environment facility operating the device. The interface presents application programs (apps) available for use by the resident on the device, via the interface. A selected app is executed and a countdown of time the selected app and/or the interface itself remains active starts. An interface tab or other visual indicator may display this countdown or it may be presented aloud. The selected app is closed or suspended upon expiration of the countdown, and the selected app, the interface and/or the device may be locked out from use by the resident for a time.

### TECHNICAL FIELD

The present disclosure relates generally to communication and media use by residents of controlled-environment facilities, and more particularly to providing a controlled-environment facility resident an interface capable of counting down the amount of time an application program and/or intelligent controlled-environment facility resident communication and media device may be used.

### BACKGROUND

According to the International Centre for Prison Studies, the United States has the highest prison population per capita in the world. In 2009, for example, 1 out of every 135 U.S. residents was incarcerated. Generally, inmates convicted of felony offenses serve long sentences in prison (e.g., federal or state prisons), whereas those convicted of misdemeanors receive shorter sentences to be served in jail (e.g., county jail). In either case, while awaiting trial, a suspect or accused may remain incarcerated. During his or her incarceration, an inmate may have opportunities to communicate with the outside world.

By allowing prisoners to have some contact with friends and family while incarcerated, the justice system aims to facilitate their transition back into society upon release. Traditional forms of contact include telephone calls, in-person visitation, conjugal visits, etc. More recently, technological advances have allowed jails and prisons to provide other types of visitation, including individual-to-individual videoconferences and online chat sessions.

Traditional communication services provided residents of controlled-environment facilities (such as correctional facilities) include allowing residents (inmates) to place outbound phone calls to non-residents of the controlled-environment facility. Additionally, non-residents can typically schedule video visitation with residents (inmates) of the controlled-environment facility. Other types of communication available to controlled-environment residents include the ability to exchange email and canned text messages between residents and non-residents of the controlled-environment facility. Basically, all of these forms of communication aim to facilitate communication between a resident of a controlled-environment facility and a non-resident.

Traditional methods for dissemination of education or entertainment media in controlled-environment facilities have included print libraries, or the like. Typically, residents of controlled-environment facilities, particularly controlled-environment facilities such as correctional institutions, are not allowed access to streaming content. Similarly, unrestricted or untethered access to wireless data communication systems is not typically allowed, such as for security reasons. However, in many cases, a resident may use as much free time as they like using communications terminals for communication, content viewing or the like.

### SUMMARY

The present invention is directed to systems and methods, which provide application program, and/or intelligent controlled-environment facility resident communication and media device, use countdowns under intelligent controlled-environment facility resident communication and media device interfaces. Such intelligent controlled-environment facility resident communication and/or media device interfaces may run on top of, or as part of, an operating system of a controlled-environment facility resident communication and/or media device. This interface may request and accept identification information from a resident of the controlled-environment facility operating the controlled-environment facility resident communication and/or media device, which may be verified.

Application programs (apps) available for use by a resident of the controlled-environment facility operating the controlled-environment facility resident communication and/or media device are presented on the controlled-environment facility resident communication and/or media device, via the controlled-environment facility resident interface. These application programs may include: a controlled-environment facility resident calling application, a video visitation application, a controlled-environment facility resident's manual, a controlled-environment facility resident form submittal program, a controlled-environment facility resident commissary ordering application, a music player, a video player, a web browser (which may be limited to only accessing secure websites and/or third party websites of approved vendors), a document reading program, an email application, a Prison Rape Elimination Act (PREA) information document, a PREA hotline, a legal research application, a job search application, a controlled-environment facility resident grievance submittal application, sick call app, education app, weather app, video mail, resident information app, games and/or the like.

The device may execute an app selected by the resident via the interface, and the interface may countdown a predetermined amount of time the selected app and/or the interface itself remains active for the resident. The controlled-environment facility resident communication and/or media device may present, via the interface, a tab and/or other visual indicator displayed on a screen of the controlled-environment facility resident communication and/or media device, displaying the countdown. Additionally or alternatively, the controlled-environment facility resident communication and/or media device may present an audio prompt notifying the resident of an amount of time remaining in the countdown, via the interface.

The selected application is closed or suspended upon expiration of the countdown, and the selected app, the interface, and/or the controlled-environment facility resident communication and/or media device itself, may be locked out for use by the resident for a same or different predetermined amount of time. The countdown, and/or the lockout, may be based, at least in part, on an identity of the resident. Additionally or alternatively, the predetermined amount of time of the countdown and/or the lockout may be based, at least in part, upon a type of the app, an Internet site being accessed, availability of another controlled-environment facility resident communication and/or media device to other residents of the controlled-environment facility in the same area as the controlled-environment facility resident communication and/or media device; a number of residents in the area, time of day, resident classification or type, and/or the like.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor(s), wherein the memory is configured to store program instructions executable by the processor(s) to cause the system(s) to execute one or more operations disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic illustration of an example communications environment, wherein example embodiments of the present systems and methods for providing intelligent controlled-environment facility resident communication and/or media device interfaces may be employed, according to some embodiments of the present systems and methods;

FIG. 2 is a diagrammatic illustration of an example intelligent controlled-environment communication and/or media device, showing an example application program or intelligent controlled-environment facility resident communication and/or media device countdown implementation, according to some embodiments of the present systems and methods;

FIG. 3 is a flowchart of an example process for providing an application program or intelligent controlled-environment facility resident communication and/or media device countdown, via an intelligent controlled-environment facility resident communication and/or media device interface, in accordance with some embodiments of the present systems and methods; and

FIG. 4 is a block diagram of a computer system, device, station, or terminal configured to implement various techniques disclosed herein, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For example, various types of controlled-environment facilities are present in today's society, and persons may be voluntary or involuntary residents of such facilities, whether temporarily or permanently. Examples of controlled-environment facilities may include correctional institutions (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, barracks, etc.), and the like. For convenience of explanation, various examples discussed herein are presented in the context of correctional facilities, or the like. For instance, in some of the embodiments discussed below, a controlled-environment facility may be referred to as a correctional facility, jail or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etc.).

The present systems and methods relate generally to communication and media use by residents of controlled-environment facilities, and more particularly to providing a controlled-environment facility resident an interface capable of counting down the amount of time an application program, and/or intelligent controlled-environment facility resident communication and media device, may be used. Such an intelligent controlled-environment facility resident communication and media device may be an Intelligent Facility Device (IFD) (e.g. a video phone particularly adapted for use in a controlled-environment facility) or an Intelligent Resident Device (IRD) (e.g. a personal wireless devices, such as a tablet computing device or smartphone, which may be adapted and/or approved for use in controlled-environment facility), described in greater detail below. As used herein the term countdown or other similar references thereto, such as “counting down,” may also encompass “count-ups,” such as where it may be desirable to a resident to track the amount of time an app is used (for a particular activity) (e.g. for a call), or the like. In accordance with embodiments of the present systems and methods, a controlled-environment facility resident interface runs on top of, or as part of, an operating system of a controlled-environment facility resident communication and/or media device. The interface may request, accept and verify identification information from a resident of the controlled-environment facility operating the device. The interface presents application programs (apps) available for use by the resident on the device, via the interface. A selected app is executed and a countdown starts of the amount of time the selected app remains active, and/or of the amount of time the interface itself remains active. An interface tab and/or other visual indicator may display this countdown, or it may be presented aloud. The selected app is closed or suspended upon expiration of the countdown, and the selected app, the interface, and/or the device, may be locked out for use by the resident for a time.

Previously, when using intelligent controlled-environment facility communication and media devices, such as an IFD or an IRD, the amount of time a resident may use a particular terminal for communication, content viewing, or the like was not typically regulated or controlled. Hence, previously, the resident could stay at an IFD or IRD for as long as he/she wants. Such a situation could arise when a resident is “looking for something to do,” wasting time, hindering another resident from access, etc. Facilities may also want to limit app availability to residents on specific days, or times, or by resident classification, or the like. For example, in a correctional environment, death row inmates may not be allowed access to job search apps. Embodiments of the present systems and methods provide countdowns on resident communication and/or media devices to limit resident access to various apps. Such embodiments may create a counter for apps on the resident communication and/or media platform, where it can be limited how long a resident can use an application at one time. Such a time limit may be may be based on the app being used, a (web) site being accessed, the identity of the resident accessing the IFD or IRD (e.g. whether the resident has a history of monopolizing terminals, etc.), etc. Such embodiments may automatically end use of the app, and/or the platform itself for the resident and not allow him or her to access the application and/or platform again for a predetermined number of minutes, again, for example based on the app used, site(s) accessed, identity of the resident accessing the terminal, etc. Thereby, embodiments of the present systems and methods encourage the resident to perform the tasks they need to perform quickly, in the time allotted, so others can use the terminal. This allows more resident access to limited resources IFDs, bandwidth, etc.

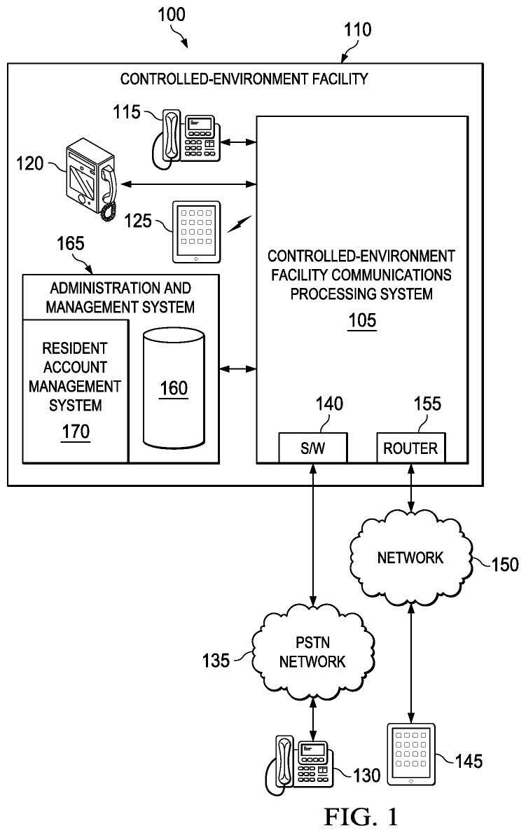

FIG. 1 is a diagrammatic illustration of example communications environment 100, wherein example embodiments of the present systems and methods may be employed, according to some embodiments. As shown, communication processing system 105 may provide telephone services, videoconferencing, online chat, and other communication services to residents of controlled-environment facility 110. In some cases, such as illustrated, communication system 105 may be co-located with controlled-environment facility 110. Alternatively, communication system 105 may be centrally or remotely located with respect to one or more controlled-environment facilities and/or may provide communication services to multiple controlled-environment facilities. More generally, however, it should be noted that communication system 105 may assume a variety of forms, and may be configured to serve a variety of facilities and/or users, whether within or outside of a controlled-environment facility.

Residents may use more-or-less conventional telephones 115 to access certain communication services. However, in accordance with embodiments of the present systems and methods, residents may also use a controlled-environment communication and/or media device or the like. For example, a resident may use a video communication device 120, or the like, to place voice calls, as well as for video communication. Such a video communication device may be referred to as an Intelligent Facility Device (IFD), which may be a video phone particularly adapted for use in a controlled-environment facility. Generally speaking, multiple video communication devices/IFDs 120 are disposed in controlled-environment facility, and may be disposed in a visitation room, in a pod, as part of a kiosk, etc. Additionally or alternatively, in accordance with embodiments of the present systems and methods, personal computer wireless devices, such as a tablet computing device or smartphone (125), which may have been adapted and/or approved for use in controlled-environment facility, may be used by controlled-environment facility residents for communication. Such a device may be referred to as an Intelligent Inmate Device (IID) in a correctional institution environment, and/or an Intelligent Resident Device (IRD), or the like, in controlled-environment facilities, in general. As will be appreciated, IFD 120, IRD 125, or other similar devices have video conferencing capabilities, or the like, to enable a party to participate in video communication sessions with other call parties, such as non-residents of the controlled-environment facility, via video communication, secure online chat, etc. Regardless, IFDs, IIDs, IRDs, etc. may be generally referred to herein as a controlled-environment communication and/or media devices, or the like.

In various embodiments, video communication devices, IFDs 120, may be implemented as a computer-based system. For example, each of IFD 120 may include a display, camera, and handset. The display may be any suitable electronic display such as, for example, a Liquid Crystal Display (LCD), a touchscreen display (e.g., resistive, capacitive, etc.), or the like, whereas the camera may be any suitable imaging device such as, for instance, a video camera or webcam equipped with Charge-Coupled Devices (CCDs), Complementary Metal-Oxide-Semiconductor (CMOS) active pixel sensors, etc. A handset may be similar to a traditional telephone handset including an earpiece portion (with a loudspeaker), a handle portion, and a mouthpiece portion (with a microphone). During a video communication session, IFD 120 may be configured to capture a video image of a resident to be transmitted to a non-resident using the camera, and to display a video image of the non-resident to the resident using the display. IFD 120 may also be configured to capture an audio signal from the resident to be transmitted to a non-resident using the mouthpiece portion of the handset, and to provide an audio signal from the non-resident to the resident using the earpiece portion of the handset. Additionally or alternatively, audio received from the non-resident may be reproduced via a loudspeaker, and audio provided by the resident may be captured via a microphone. In some cases, IFD 120 may assume the form of any computer, tablet computer, smart phone, etc., or any other consumer device or appliance with videoconferencing capabilities. For example, in a correctional facility environment a tablet computing device may be mounted on a wall, in a hardened case, as a video communication device or IFD.

IRDs 125 may be tablet computing devices, smartphones, media players, or the like adapted and/or approved for use by residents of the controlled-environment facility (within the controlled-environment facility). Each IRD 125 may be particularly adapted for use in a controlled-environment. For example, in a correctional institution, jail, or the like, such an IRD, or IID, may have a specially adapted operating system and/or may be “stripped-down,” particularly from the standpoint of what apps and/or hardware are provided or allowed on IRD 125, and/or connectivity afforded such a IRD. For example, such an IRD may employ an operating system kernel such one based upon an open source platform such as the CyanogenMod-based operating system, which may be built for use in such an IRD in a controlled-environment facility. As a further example, the IRD may be adapted to only connect to a network provided by the controlled-environment facility, and/or in only certain locations, within the controlled-environment facility, such as may be controlled by availability of Wi-Fi access, or the like, only being available in certain areas. That is, for example, where streaming and/or downloading may be compartmentalized, leveraging the structure of the controlled-environment facility, for example, limiting the availability of a Wi-Fi signal, providing the stream through the placement of wireless access points, antenna directionality of such wireless access points, and/or the like. Further, the IRD may allow access to apps or content only upon application of security measures, by the IRD. Such security measures may include determining, by the IRD, DNS spoofing, DNS redirection, use of proxy servers for privacy and security, biometric validation, password validation, and/or the like. Also, In accordance with embodiments of the present systems and methods, the IRD may have a few fixed apps pre-installed on the device, and installation of further apps on the device may be forbidden (i.e. prevented by modifications to the device's operating system, or the like) and/or restricted, such as by requiring permission from a facility administrator, or the like. Apps provided on IRDs might include apps of particular interest to residents of the controlled-environment facility. For example, IRDs provided to inmates of correctional facilities, might include apps that may be of particular use to an inmate, in general, such as access to a legal research service, or of more specific interest, such as providing an inmate nearing release, access to employment searching apps or the like. Hence, such inmate IRDs may be used to help soon to be released inmates transition. For example, the IRD may be used to communicate with a future employer, or the like. As such, IRDs may be sponsored, or otherwise subsidized by organizations or companies, assisting with the transition of inmates into society.

In accordance with embodiments of the present systems and methods, controlled-environment facility resident communication and/or media device, IFD 120, IRD 125, or the like, may present via a resident interface, apps such as: a controlled-environment facility resident calling application, a video visitation application, a controlled-environment facility resident's manual, a controlled-environment facility resident form submittal program, a controlled-environment facility resident commissary ordering application, a music player, a video player, a web browser (which may be limited to only accessing secure websites and/or third party websites of approved vendors), a document reading program, an email application, a Prison Rape Elimination Act (PREA) information document, a PREA hotline, a legal research application, a job search application, a controlled-environment facility resident grievance submittal application, sick call app, education app, weather app, video mail, resident information app, games and/or the like.

In various embodiments, to access communication services, a resident may initiate telephone services by lifting the receiver on telephone 115 or IFD 120, and/or otherwise initiating a call, such as by launching a communications application program (app) on IRD 125. At which time, the resident may be prompted to provide a personal identification number (PIN), other identifying information or biometrics. An interactive voice response (IVR) unit (not shown, but which may be integrated into communication processing system 105) may generate and play a prompt, or other messages, to the resident on device 115, 120 or 125. Under the control of communication processing system 105, devices 115, 120 and 125 may be capable of connecting to a non-resident's (i.e., a person not incarcerated or otherwise committed to a controlled-environment facility) telephone 130 across a publicly switched telephone network (PSTN) 135. For example, telephone 135 may be located at a non-resident's home or office, at a resident visitation center, etc. Switch 140, in communication processing system 105, may be used to connect calls across PSTN 135. Additionally or alternatively, the non-resident may communicate using device 145, which may be a mobile phone, tablet computing device, personal computer, or the like, which may be connected through an Integrated Services Digital Network (ISDN), Voice-over-IP (VoIP), or packet data network (such as, for example the Internet), a wireless communications network, or the like 150. Router 155 of communication processing system 105 is used to route data packets associated with a call connection to device 145. For example, a non-resident party may have a device 145 with a built-in front-facing camera, or the like, and an integrated display (e.g., a smart phone, tablet, etc., as illustrated), a personal computer with a webcam, etc. A network connection between the parties may be established and supported by an organization or commercial service that provides computer services and software for use in telecommunications and/or VOIP, such as SKYPE®. Additionally or alternatively, the correctional facility and/or the destination may use videoconferencing equipment compatible with ITU H.323, H.320, H.264, and/or V.80, or other suitable standards.

In addition to providing certain visitation and communication operations, communication processing system 105 may attempt to ensure that a resident's calls, video conferences, online chats, etc. are performed only with non-residents whose identities, devices, email addresses, phone numbers, etc. are listed in that resident's Pre-Approved Contact (PAC) list. Each resident's PAC list may be stored, for example, in database 160 maintained by controlled-environment Administration and Management System (AMS) 165. In addition to PAC list(s), AMS 165 may also store Resident Profile Data (RPD), as well as communication and/or visitation rules applicable to each resident. As an example, in the context of a correctional facility, AMS 165 may be referred to as a Jail Management System (JMS). Within the AMS or JMS 165, database 160 may include information such as balances for resident trust and calling accounts; trial schedule; conviction data; criminal record; sentencing data, such as time served, time remaining to be served, and release date; cell and cellmate assignments; resident restrictions and warnings; commissary order history; telephone call history; call recordings; known or suspected gang or criminal affiliations; known or suspected affiliates, accomplices, or gang members; and any other information that may be relevant or useful to correctional facility staff to house and maintain residents. Controlled-environment facility resident account management system 170, which may be a separate system, or which may be a part or function of AMS 165, as illustrated, may maintain resident accounts to the benefit of the respective resident, such as a resident communications accounts, which may be used to pay for communications, such as phone calls, video visitation, internet chats, emails, text messages, or the like. Such communications accounts may in some embodiments, include community communications accounts maintained by controlled-environment facility resident account management system 170, administration and management system 165, and/or the like, of at least one controlled-environment facility, to the benefit of a number of residents of the same or different facilities for payment of communications.

In some implementations, communication processing system 105 may be configured to perform video communication monitoring operations configured to monitor and or record video communication sessions (e.g., as electronic video files). In scenarios where communication processing system 105 is located within the controlled-environment facility, it may have direct access to AMS or JMS 165. In other embodiments, however, communication processing system 105 may be located remotely with respect to the controlled-environment facility, and access to AMS or JMS 165 may be obtained via a computer network such as, for example, network 150.

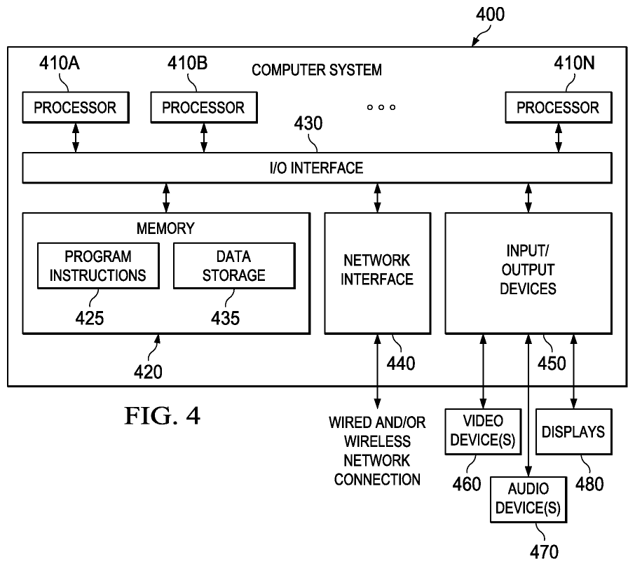

Thus, in accordance with embodiments of the present systems and methods, a controlled-environment facility resident communication and/or media device, IFD 120, IRD 125, or the like, may include at least one processor and a memory coupled to the at least one processor, such as discussed in greater detail below, with reference to FIG. 4. This memory may be configured to store program instructions executable by the at least one processor. Such program instructions may include a controlled-environment facility resident communication and/or media device operating system and a controlled-environment facility resident interface program. This interface program may include program instructions executable by the at least one processors to cause controlled-environment facility resident communication and/or media device 120 or 125 to run the controlled-environment facility resident interface on top of, or as part of, the operating system and present apps available for use by a controlled-environment facility resident on the controlled-environment facility resident communication and/or media device. This interface may act as a resident communications platform, and also or alternatively, provide automated login for interface applications, provide a(n) (interactive) controlled-environment facility bulletin board, etc. The interface may request and accept identification information from the resident, such as information that may confirm the identity of the resident. This identification may be verified, such as through the interface, by controlled-environment facility communications processing system 105, AMS 165, and/or the like, to complete such a login. In accordance with embodiments of the present systems and methods, the interface program instructions may also permit and/or facilitate execution of the apps, such as when one of these apps is selected by the resident, via the interface. The interface may countdown a predetermined amount of time the selected app remains active, a predetermined number of times that an app can be opened, a predetermined number of times that a form can be submitted, or a predetermined time an app remains open and/or is executed. The interface may close or suspend the application upon expiration of this countdown to thereby restrict the resident from use of the app and/or in the interface itself. Alternatively or additionally, the interface may countdown the amount of time the resident is allowed to use (e.g. is allowed to remain logged-in on) controlled-environment communication and/or media device 120 or 125. Further, the controlled-environment facility resident interface may lockout the selected app and/or the interface itself for use by the resident for a predetermined amount of time. Thus, embodiments of the present systems and methods may not only limit the amount of time a particular application remains open, but also when it may again be opened, the number of times per day (or per time period) that a resident is allowed to access an app, the number of grievances (or other resident forms) that a resident may submit per day (or per time period), and/or the like.

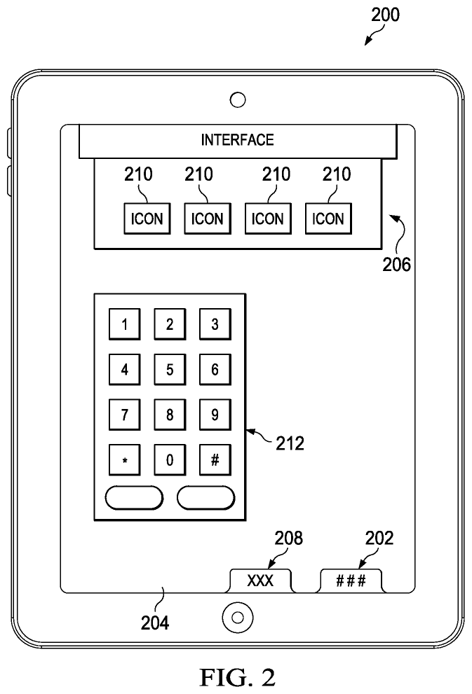

FIG. 2 is a diagrammatic illustration of example intelligent controlled-environment communication and/or media device 200, showing an example application program or intelligent controlled-environment facility resident communication and/or media device countdown implementation, according to some embodiments of the present systems and methods. An IRD (125) is illustrated in FIG. 2 as intelligent controlled-environment communication and/or media device 200. However, similar device and/or app countdown functionality may be provided by an IFD (120), or the like. The aforementioned device and/or app countdown functionality, might, at least in part, take the form of tab 202, or the like displayed on the controlled-environment facility resident communication and/or media device's screen 204. This tab, and/or other visual indicator, may display the countdown, such that the resident is informed of the amount of time he or she has remaining to use the app. Such a tab and/or other visual indicator may be displayed in, or in conjunction with, controlled-environment facility resident interface 206 on screen 204 of controlled-environment communication and/or media device 200. This tab and/or other visual indicator may also represent the open application, and further tabs and/or other visual indicators 208 may represent other open apps, and may include their own countdown, in accordance with some embodiments of the present systems and methods. Such applications may be selected from interface icons 210. The tab(s) and/or other visual indicator(s) may also display other information such as a name of the app, the name of an open document. Further, some tabs and/or other visual indicators may also provide a “count-up” in certain situations, such, by way of example, during a call (e.g. using illustrated open calling application 212) or video visitation that may be charged based on time. Tabs and/or other visual indicators may, in accordance with various embodiments, be used for switching between represented applications, documents, or the like.

Additionally or alternatively, the interface may present an audio prompt, such as via speakers integrated into intelligent controlled-environment communication and/or media device 200, notifying the resident of an amount of time remaining in the countdown. For example, such an audio prompt may play an audible countdown of time remaining for the resident to use the app. Such an audio countdown may provide an audio prompt at intervals, which may decrease as the countdown nears its end. As a particular example, audio prompts may be provided at five minutes remaining, two minutes, one minute, thirty seconds, fifteen seconds, ten seconds, and then countdown from five seconds until shutdown of the app, or the like. Further, or alternative prompts could be comprised of or include flashing indicators, vibration, or the like.

In accordance with various embodiments of the present systems and methods, following expiration of the countdown the application, or interface 206 itself, may be locked-out from use by the resident for a predetermined amount of time. Locking the resident out from use of the interface may, in effect, lock the resident out of use of controlled-environment facility resident communication and/or media device 200. That is, in accordance with various embodiments of the present systems and methods, the interface may be the only method the resident is afforded to access the device under the controlled-environment facility resident communication and/or media device operating system, such as a modified operation system described above. Hence, locking the resident out of interface 206 may, in turn, lock the resident out of device 200, in accordance with such embodiments.

The countdown and/or the length of the lockout may be based, at least in part on the identity of the resident, and/or other factors. For example, the predetermined amount of time for the countdown or lockout may be based upon any one or more of a type of the app, the resident him or herself or factors related the resident, an Internet site being accessed, availability of another controlled-environment facility resident communication and/or media device to other residents of the controlled-environment facility in the same area as the controlled-environment facility resident communication and/or media device, the a number of residents in the area, time of day, resident classification or type, and/or the like.

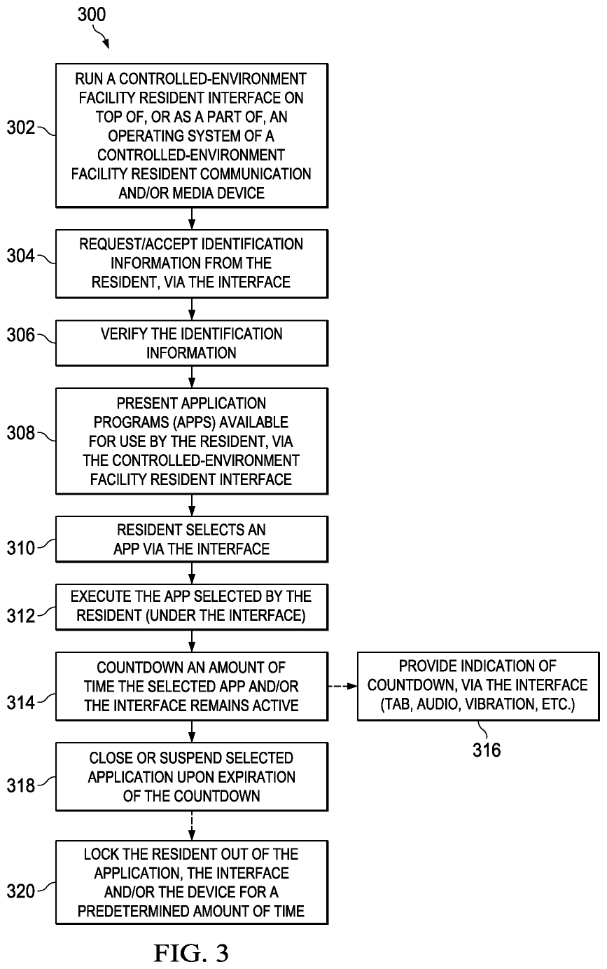

FIG. 3 is a flowchart of example process 300 for providing an application program or intelligent controlled-environment facility resident communication and/or media device countdown on intelligent controlled-environment communication and/or media devices (120, 125, 200, etc.), in accordance with some implementations of the present systems and methods. Method 300 may include running a controlled-environment facility resident interface on top of, or as part of, an operating system of the controlled-environment communication and/or media device (120, 125, 200, etc.) at 302. At 304, identification information may be requested and accepted from the resident, such as via the interface. Upon verification of the identification information at 306, such as through the interface, by a controlled-environment facility communications processing system (105), an AMS/JMS (165), and/or the like, apps available for use by a resident of the controlled-environment facility who is operating the controlled-environment communication and/or media device may be presented, via the controlled-environment facility resident interface (206) at 308, such as via icons (210). This presents the app in a presentation layer on top of an operating system layer on the device. These apps maybe a part of the interface, integrated into the interface, or may run on top of, or as part of, the interface. Selection of one of the apps by the resident at 310 may result in launching (or execution) of the selected app at 312, which may include logging the resident into the selected app using stored application program login information, with respect to the app, for the resident. At 314 the interface may count down a predetermined amount of time the selected app (and/or the interface itself) is allowed to remain active, may remain open and/or is otherwise allowed to be executed or run. This countdown may be based on the identity of the resident, and/or other factors, such as discussed above. A tab (202), or the like, such as may be displayed on a screen (204) of the controlled-environment facility resident communication and/or media device (120, 125, 200, etc.) may show the countdown at 316. Additionally or alternatively, an audio prompt may be presented, notifying the resident of an amount of time remaining in the countdown, or other means, such as vibration, may be used to alert the resident to time remaining in the countdown at 316. At the expiration of the countdown, the selected application (and/or the interface itself) may be closed or otherwise shutdown or suspended at 318.

In accordance with some embodiments of the present systems and methods, upon expiration of the countdown at 314 and the app's shutdown at 318, the selected app may be locked out for use by the resident for a predetermined amount of time, at 320. In accordance with further or alternative embodiments of the present systems and methods, the interface and/or the device itself may be locked out for use by the resident at 320, for a predetermined amount of time following expiration of the countdown at 314 and shutdown of the app at 318.

The predetermined time of the lock out at 320 may be based, at least in part, on an identity of the resident, such as ascertained at 304 and 306. In accordance with further embodiments of the present systems and methods, the length of the countdown and/or the predetermined amount of time the app is locked out may further or alternatively be based, at least in part on a type of the app, an Internet site being accessed, availability of another controlled-environment facility resident communication and/or media device to other residents of the controlled-environment facility in the same area as the controlled-environment facility resident communication and/or media device, the number of residents in the area, and/or time of day, resident classification or type, and/or the like.

Embodiments of the present systems and methods may be dynamic, in that the predetermined amounts of time for the countdown and/or lockout may be based on variable factors. For example, when a particular resident repeatedly runs out the entire countdown and is thereby repeatedly forced off of a terminal or out of a particular app, the countdown for that resident on a terminal or for that app may be shortened, as a more-or-less punitive measure. As another example, if other terminals are available in the same area (e.g. in the same cellblock, pod, or the like, in a correctional environment) countdowns may be extended or suspended altogether, while logouts may be shortened or suspended altogether. Use of particular apps may be more readily extended. For example, in a correctional environment, access to a law library application or (web) site may be more readily extended than access to an entertainment-based app or site. Similarly an application that generates revenue for the facility, a facility communications provider, or the like may have longer countdowns or none at all, while having shorter lockouts or none at all. Regardless, scheduled events, such as a scheduled video visitation may, in accordance with various embodiments, supersede any countdown, lockout, terminal use by others than the resident scheduled, or the like. For example, in a corrections environment, an inmate that has a video visitation scheduled would be allowed to access a terminal even if the resident is currently locked-out of access. Similarly, even if the inmate has a countdown for interface/terminal use shorter than the scheduled video visitation, the resident would not be cutoff during the video visitation or locked out of the terminal.

In accordance implementations such as described above with respect to FIG. 3, applied by way of example to IRD 200 of FIG. 2, open interface 206 such as may be presented following verification of the residents identity at 306 is shown therein. Calling application 212 is shown open, with a countdown indicated in tab 202 (and/or other visual indicator), such as a time allowed for the call to continue. As noted, a “count-up” may alternatively be provided, such as in tab 202, for a phone call or the like, such as may be carried out using calling app 212, so the resident can track call usage. Once a countdown, such as may be displayed on tab 202 expires the app being counted down may be closed or suspended, and the resident may not be allowed to reopen that app on interface 206 for a predetermined amount of time. Alternatively, the resident may be locked out of interface 206 entirely, which may effectively prevent use of device 200 for the predetermined amount of time.

Embodiments of the present systems and methods for providing multitasking on intelligent controlled-environment communication and media devices, as described herein, may be implemented or executed, at least in part, by one or more computer systems. One such computer system is illustrated in FIG. 4. In various embodiments, computer system 400 may be a server, a mainframe computer system, a workstation, a network computer, a desktop computer, a laptop, a tablet computing device, media player, or the like. For example, in some cases, one or more of controlled environment facility management system 105, IFD 120, IRD 125, non-resident media device 145, AMS 165 (resident account management system 170), intelligent controlled-environment communication and/or media device 200, and/or the like, may be implemented, in part, or in whole, as a computer system such as computer system 400. Likewise a computer system, such as computer system 400 may implement one or more steps of example process 300 described above with respect to FIG. 3. In various embodiments two or more of these computer systems may be configured to communicate with each other in any suitable way, such as, for example, via a network. For example, in FIG. 1, IFD 120 and/or IRD 125 are illustrated as communicating with non-resident equipment 130 and/or 145, via one or more of networks 135 and 150, through controlled-environment facility communication processing system 105. As a further example, IRD 125 is illustrated as wirelessly communicating with controlled-environment facility communication management system 105 using wireless functionality, such as a wireless data network (i.e. a Wi-Fi network, or the like). In such a controlled-environment facility wireless network, IFD 120 may act as a Wi-Fi (or wired) access point or router, such as for IRD 125, in accordance with some embodiments of the present systems and methods.

As illustrated, example computer system 400 includes one or more processors 410 coupled to a system memory 420 via an input/output (I/O) interface 430. Example computer system 400 further includes a network interface 440 coupled to I/O interface 430, and one or more input/output devices 450, such as video device(s) 460 (e.g., a camera), audio device(s) 470 (e.g., a microphone and/or a speaker), and display(s) 480. Computer system 400 may also include a cursor control device (e.g., a mouse or touchpad), a keyboard, etc. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In various embodiments, computer system 400 may be a single-processor system including one processor 410, or a multi-processor system including two or more processors 410 (e.g., two, four, eight, or another suitable number). Processors 410 may be any processor capable of executing program instructions. For example, in various embodiments, processors 410 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 410 may commonly, but not necessarily, implement the same ISA. Also, in some embodiments, at least one processor 410 may be a graphics processing unit (GPU) or other dedicated graphics-rendering device.

System memory 420 may be configured to store program instructions and/or data accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described in connection with FIGS. 1 through 4, above, may be stored within system memory 420 as program instructions 425 and data storage 435, respectively. In other embodiments, program instructions and/or data may be received, sent or stored upon different types of computer-accessible media or on similar media separate from system memory 420 or computer system 400. Generally speaking, a computer-readable medium may include any tangible or non-transitory storage media or memory media such as magnetic or optical media—e.g., disk or CD/DVD-ROM coupled to computer system 400 via I/O interface 430, Flash memory, random access memory (RAM), etc. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 440.

In some embodiments, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any suitable protocol, timing or other data transformations to convert data signals from one component (e.g., system memory 420) into a format usable by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. In addition, in some embodiments, some or all of the functionality of I/O interface 430, such as an interface to system memory 420, may be incorporated into processor 410.

Network interface 440 may be configured to allow data to be exchanged between computer system 400 and other devices attached to a network, such as other computer systems, or between nodes of computer system 400. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

As shown in FIG. 4, memory 420 may include program instructions 425, configured to implement certain embodiments described herein, and data storage 435, comprising various data accessible by program instructions 425. In an embodiment, program instructions 425 may include software elements corresponding to one or more of the various embodiments illustrated in the above figures. For example, program instructions 425 may be implemented in various embodiments using any desired programming language, scripting language, or combination of programming languages and/or scripting languages (e.g., C, C++, C#, JAVA®, JAVASCRIPT®, PERL®, etc.). Data storage 435 may include data that may be used in these embodiments. In other embodiments, other or different software elements and data may be included.

A person of ordinary skill in the art will appreciate that computer system 400 is merely illustrative and is not intended to limit the scope of the disclosure described herein. In particular, the computer system and devices may include any combination of hardware or software that can perform the indicated operations. Additionally, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A controlled-environment facility resident communication and/or media device comprising:
at least one processor; and
a memory coupled to the at least one processor, the memory configured to store program instructions executable by the at least one processor, the program instructions comprising:
a controlled-environment facility resident communication and/or media device operating system; and
a controlled-environment facility resident interface program comprising program instructions executable by the at least one processor to cause the controlled-environment facility resident communication and/or media device to:
run the controlled-environment facility resident interface program on top of, or as part of, the operating system;
present, in an interface on the controlled-environment facility resident communication and/or media device, application programs available for use by a controlled-environment facility resident on the controlled-environment facility resident communication and/or media device;
execute an application program selected by the resident via the interface;
countdown a predetermined amount of time the selected application program and/or the interface remains active; and
close or suspend the selected application program and/or the interface upon expiration of the countdown.

2. The controlled-environment facility resident communication and/or media device of claim 1, wherein the controlled-environment facility resident interface program instructions are further executable by the at least one processor to cause the controlled-environment facility resident communication and/or media device to:
request and accept identification information from the resident;
verify the identification information; and
base the countdown, at least in part, on an identity of the resident.

3. The controlled-environment facility resident communication and/or media device of claim 1, wherein the controlled-environment facility resident interface program instructions are further executable by the at least one processor to cause the controlled-environment facility resident communication and/or media device to:
present a tab and/or other visual indicator, displayed on a screen of the controlled-environment facility resident communication and/or media device, displaying the countdown.

4. The controlled-environment facility resident communication and/or media device of claim 1, wherein the controlled-environment facility resident interface program instructions are further executable by the at least one processor to cause the controlled-environment facility resident communication and/or media device to:
present an audio prompt notifying the resident of an amount of time remaining in the countdown.

5. The controlled-environment facility resident communication and/or media device of claim 1, wherein the predetermined amount of time of the countdown is based, at least in part, upon a type of the application program, an Internet site being accessed, availability of another controlled-environment facility resident communication and/or media device to other residents of the controlled-environment facility in the same area as the controlled-environment facility resident communication and/or media device, a number of residents in the area, time of day, and/or resident classification or type.

6. The controlled-environment facility resident communication and/or media device of claim 1, wherein the controlled-environment facility resident interface program instructions are further executable by the at least one processor to cause the interface to lockout the selected application program, the interface and/or the controlled-environment facility resident communication and/or media device for use by the resident for a predetermined amount of time.

7. The controlled-environment facility resident communication and/or media device of claim 6, wherein the controlled-environment facility resident interface program instructions are further executable by the at least one processor to cause the controlled-environment facility resident communication and/or media device to:
request and accept identification information from the resident;
verify the identification information; and
base the predetermined time of the lockout, at least in part, on an identity of the resident.

8. The controlled-environment facility resident communication and/or media device of claim 6, wherein the predetermined amount of time of the lockout is based, at least in part, upon a type of the application program, an Internet site being accessed, availability of another controlled-environment facility resident communication and/or media device to other residents of the controlled-environment facility in the same area as the controlled-environment facility resident communication and/or media device, a number of residents in the area, time of day, and/or, resident classification or type.

9. The controlled-environment facility resident communication and/or media device of claim 1, wherein the controlled-environment facility resident interface program instructions are further executable by the at least one processor to cause the controlled-environment facility resident communication and/or media device to limit the number of times per day, or per predetermined time period, the resident is allowed to access a particular application program and/or file a resident form or grievance.

10. The controlled-environment facility resident communication and/or media device of claim 1, wherein the application programs comprise at least one of a controlled-environment facility resident calling application, a video visitation application, a controlled-environment facility resident's manual, a controlled-environment facility resident form submittal program, a controlled-environment facility resident commissary ordering application, a music player, a video player, a web browser, a document reading program, an email application, Prison Rape Elimination Act information document, Prison Rape Elimination Act hotline, a legal research application, a job search application, a controlled-environment facility resident grievance submittal application, a sick call application program, education application program, weather application program, video mail, resident information application program, and/or a game.

11. A method for controlling access time to application programs presented under a controlled-environment facility resident interface on a controlled-environment facility resident communication and/or media device, the method comprising:
running a controlled-environment facility resident interface on top of, or as part of, an operating system of a controlled-environment facility resident communication and/or media device;
presenting, on the controlled-environment facility resident communication and/or media device, via the interface, application programs available for use by a resident of the controlled-environment facility operating the controlled-environment facility resident communication and/or media device;
executing an application program selected by the resident via the interface;
counting down a predetermined amount of time a selected application program and/or the interface remains active; and
closing or suspending the selected application program and/or the interface upon expiration of the predetermined amount of time.

12. The method of claim 11, further comprising:
requesting and accepting, by the interface, identification information from the resident;
verifying the identification information; and
basing, by the interface, the countdown, at least in part, on an identity of the resident.

13. The method of claim 11, wherein counting down a predetermined amount of time the selected application program and/or interface remains active further comprises displaying a tab and/or other visual indicator on a screen of the controlled-environment facility resident communication and/or media device showing the countdown.

14. The method of claim 11, wherein counting down a predetermined amount of time the selected application program and/or interface remains active further comprises presenting an audio prompt notifying the resident of an amount of time remaining in the countdown.

15. The method of claim 11, wherein the predetermined amount of time the selected application program and/or the interface remains active is based, at least in part, upon the application program, an Internet site being accessed, availability of another controlled-environment facility resident communication and/or media device to other residents of the controlled-environment facility in the same area as the controlled-environment facility resident communication and/or media device, a number of residents in the area, time of day, and/or resident classification or type.

16. The method of claim 11, further comprising locking the selected application program, the interface and/or the controlled-environment facility resident communication and/or media device out for use by the resident for a predetermined amount of time.

17. The method of claim 16, further comprising:
requesting and accepting, by the interface, identification information from the resident;
verifying the identification information; and
basing, by the interface, the predetermined time of the lock out, at least in part, on an identity of the resident.

18. The method of claim 16, wherein the predetermined amount of time the application program is locked out is based, at least in part, upon a type of the application program, an Internet site being accessed, availability of another controlled-environment facility resident communication and/or media device to other residents of the controlled-environment facility in the same area as the controlled-environment facility resident communication and/or media device, a number of residents in the area, time of day, and/or resident classification or type.

19. The method of claim 11, further comprising limiting the number of times per day, or per predetermined time period, the resident is allowed to access a particular application program and/or file a resident form or grievance.

20. The method of claim 11, wherein the application programs comprise at least one of a controlled-environment facility resident calling application, a video visitation application, a controlled-environment facility resident's manual, a controlled-environment facility resident form submittal program, a controlled-environment facility resident commissary ordering application, a music player, a video player, a web browser, a document reading program, an email application, Prison Rape Elimination Act information document, Prison Rape Elimination Act hotline, a legal research application, a job search application, a controlled-environment facility resident grievance submittal application, a sick call application program, education application program, weather application program, video mail, resident information application program, and/or a game.

21. A non-transitory computer-readable storage medium having a controlled-environment facility resident interface program instructions stored thereon that, upon execution by a controlled-environment facility resident communication and/or media device, cause the controlled-environment facility resident communication and/or media device to:
run a controlled-environment facility resident interface on top of, or as part of, an operating system of the controlled-environment facility resident communication and/or media device;
request and accept identification information from a resident of the controlled-environment facility operating the controlled-environment facility resident communication and/or media device;
verify the identification information;
present application programs available for use by the resident on the controlled-environment facility resident communication and/or media device, via the controlled-environment facility resident interface;
execute an application program upon selection by the resident, via the interface, of the application program;
countdown a predetermined amount of time the selected application program and/or the interface remains active;
close or suspend selected application upon expiration of the countdown;
lockout the selected application program, the interface and/or the controlled-environment facility resident communication and/or media device for use by the resident for a same or different predetermined amount of time.

22. The non-transitory computer-readable storage medium of claim 21, wherein the controlled-environment facility resident interface program instructions further cause the controlled-environment facility resident communication and/or media device to:
present a tab or other visual indicator displayed on a screen of the controlled-environment facility resident communication and/or media device displaying the countdown.

23. The non-transitory computer-readable storage medium of claim 21, wherein the controlled-environment facility resident interface program instructions further cause the controlled-environment facility resident communication and/or media device to:
present an audio prompt notifying the resident of an amount of time remaining in the countdown.

24. The non-transitory computer-readable storage medium of claim 21, wherein the controlled-environment facility resident interface program instructions further cause the controlled-environment facility resident communication and/or media device to base the countdown and/or the lockout, at least in part, on an identity of the resident.

25. The non-transitory computer-readable storage medium of claim 21, wherein the controlled-environment facility resident interface program instructions further cause the controlled-environment facility resident communication and/or media device to limit the number of times per day, or per predetermined time period, the resident is allowed to access a particular application program and/or file a resident form or grievance.

26. The non-transitory computer-readable storage medium of claim 21, wherein the controlled-environment facility resident interface program instructions further cause the controlled-environment facility resident communication and/or media device to base the predetermined amount of time of the countdown and/or the lockout, at least in part, upon a type of the application program, an Internet site being accessed, availability of another controlled-environment facility resident communication and/or media device to other residents of the controlled-environment facility in the same area as the controlled-environment facility resident communication and/or media device; a number of residents in the area, time of day, and/or resident classification or type.
